(19) United States
(12) Patent Application Publication
(10) Pub. No.: US 2013/0068919 A1
(43) Pub. Date: Mar. 21, 2013

(54) UNIVERSAL OBJECT RETENTION SYSTEM AND METHOD THEREOF

(71) Applicant: Dario Cesar Antonioni, Playa Vista, CA (US)

(72) Inventor: Dario Cesar Antonioni, Playa Vista, CA (US)

(21) Appl. No.: 13/385,596

(22) Filed: Sep. 6, 2011

(51) Int. Cl. F16M 13/00; F16L 3/26; B60R 7/00; A47B 13/00; A47B 81/00; B42F 13/40; F16M 13/02

(52) U.S. Cl. CPC F16M 13/00; B42F 13/40; F16L 3/26; F16M 13/022; A47B 13/00; A47B 81/00; B60R 7/00
USPC 248/614; 402/4; 248/49; 108/28; 211/120; 211/113; 224/275

(57) ABSTRACT

An object retention system incorporated into an office environment is disclosed. The object retention system may be incorporated into panels, dry erase boards, adjustable partitions and panels. The object retention system may also be integrated into products and panels for non office environments.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The object retention system disclosed herein relates to a device for storing a wide variety of objects such as personal articles, digital gear, electronic gadgets, cosmetics, etc. of different size and shape. The object retention system may be incorporated into office furniture and other products and environments.

In the office environment, an employee will have numerous small objects on his/her desk. By way of example and not limitation, these small objects may include pens, pencils, markers, reading glasses, cell phones, erasers, stapler removers, etc. These objects are typically stored in a drawer or other storage bin when not in use. These articles are thrown into the storage bin (e.g., drawer) without any organization or order. In order to retrieve any particular item, one must look through the pile of personal items to find the particular desired item. This is an inefficient method of retrieval of items. Moreover, this method also creates clutter in the storage bin. Alternatively, these articles are left on the desk top and clutter the person's work space.

In a different environment such as a kitchen, shower, bathroom, etc., the same problem arises. The kitchen has numerous utensils, bottles, etc. which may be randomly stored in a drawer. The shower may have a number of shampoos, soaps, etc. The bathroom may also have a number of items which are randomly stored in a drawer or cabinet. These items clutter the space and makes finding any particular item difficult to retrieve.

Accordingly, there is a need in the art for a system to organize and store personal objects in an office environment.

### BRIEF SUMMARY

The object retention system disclosed herein addresses the needs discussed above, discussed below and those that are known in the art.

The object retention system may have a plurality of interwoven vertical and horizontal elastic bands that can be used to hold objects and personal items such as digital gear, etc. and clear clutter off of a person's desk. The object retention system may be incorporated into office furniture such as panels, dry erase boards, pinable surfaces, etc. As discussed herein, the object retention system may be utilized as a cable management system as well as a method for organizing digital gear on a person's desk. Additionally, the object retention system may be incorporated into other environment such kitchen, bathroom, automobile, marine, etc.

More particularly, an object retention system is disclosed which comprises a generally rigid support; a plurality of elastic bands attached to the generally rigid support, each of the elastic bands attached to the rigid support parallel to each other, distal end portions and intermediate portions of the bands attached to the generally rigid support for providing short band sections to hold smaller objects; wherein the intermediate portions collectively depict an image or pattern.

The object retention system may further comprise a loop attached to the generally rigid support for receiving a hook to hang the object retention system from the hook.

The support may be curved, flat, convex or concave.

The elastic bands have different widths. Adjacent elastic bands abut each other. Alternatively, adjacent elastic bands are gapped away from each other.

The image or pattern may be a curved line, a logo, a diagram or combinations thereof.

A clip may be attached to the second side for removably mounting the system to a wall, wall panel, or dry erase board.

A magnet may be attached to the second side for removably mounting the system to a wall, wall panel, easel or dry erase board.

The support may extend from a first cable termination point to a second cable termination point for routing one or more cables from the first to second cable termination points.

The support may have a channel for receiving a desk top to mount the system to the desk top.

The system may be removably clipped onto a panel.

The support may be a dry erase board or an easel.

In another embodiment, an office system is disclosed which comprises a table top for providing a work space to a person; a panel disposed adjacent to the table top; and an object retention system slideably attached to the panel.

The object retention system may comprise a generally rigid support; a plurality of elastic bands attached to the support, objects capable of being disposed between one or more of the elastic bands and the generally rigid support to hold the objects; and a sliding system attached to the panel and the object retention system to allow the object retention system to slide with respect to the panel. The object retention system may slide laterally or vertically with respect to the panel.

In another embodiment, an office system may comprise a table top for providing a work space to a person; a panel removably attachable to the table top; and an object retention system attached to the panel.

The object retention system may comprise a plurality of elastic bands attached to the panel. The objects are capable of being disposed between one or more of the elastic bands and the panel to hold the objects.

The panel may a C shaped channel which receives the table top to removably attach the panel and the object retention system to the table top.

The panel and the object retention system may have a magnet attachment system for removably attaching the object retention system to the panel. The magnet system may comprise a first part of the magnet system attached to the panel; and a second part of the magnet system attached to the object retention system; wherein the first part and the second part are magnets, a magnet and a ferromagnetic material or a ferromagnetic material and a magnet.

The panel may be a dry erase board and the object retention system may be removably attachable to the panel to cover the dry erase board.

In another embodiment, an office system may comprise a table top for providing a work space to a person; a slatwall panel disposed adjacent to the table top; an object retention system attachable to the panel.

The object retention system may comprise a generally rigid support; a plurality of elastic bands attached to the support, objects capable of being disposed between one or more of the elastic bands and the generally rigid support to hold the objects; a plurality of slatwall panel hooks attached to the generally rigid support for mounting the object retention system to the panel. The object retention system may have a rectangular configuration and is mountable to the slatwall panel in a portrait or landscape orientation.

In another embodiment, a cable management device may comprise a generally rigid support; a plurality of first elastic bands attached to the generally rigid support, each of the elastic bands arranged parallel to each other, distal end portions and intermediate portions of the bands attached to the generally rigid support; a plurality of second elastic bands attached to the second side of the generally rigid support at an angle greater than 1 degree up to and including 90 degrees with respect to the plurality of first elastic bands; wherein the generally rigid support being attachable to a wall or panel for routing and securing one or more cables from a first termination point to the second termination point.

In another embodiment, a paper binder is disclosed. The paper binder may comprise a spine defining front and back edges; a front cover pivotally attached to the front edge of the spine; a back cover pivotally attached to the back edge of the spine; and a plurality of transverse straps attached one or both of the front and back covers. The plurality of transverse straps may be attached one or more of interior and exterior surfaces of the front and back covers.

In another embodiment, an all purpose object retention system is disclosed. The system may comprise a rigid backing defining opposed surfaces; a plurality of transverse straps mounted to one or both of the opposed surfaces of the rigid backing; a border disposed about a periphery of the rigid backing. The border may have at least one tab for securing an attachment mechanism to the object retention system. The border may have four tabs with one tab at a corner of a rectangular rigid backing.

The tab may have a hole which permits attachment of one or more of an eye hole strap, clip, leash and suction cup to the tab.

In another embodiment, an object retention system for mounting to a rear side of an automobile seat is disclosed. The system may comprise an upper panel having a plurality of transverse straps; a securing mechanism comprising first and second bands attached to the upper panel which ends are removably attachable to each other for securing the upper panel to a head rest of the automobile seat; a lower panel pivotal with respect to the upper panel; wherein the lower panel is insertable into a back pocket of the automobile seat.

The system may further comprise an intermediate panel with the upper and lower panels pivotally secured to opposed sides of the intermediate panel.

In another embodiment, an upright object retention system is disclosed. The system may comprise at least three serial panels with a plurality of transverse straps attached to one or more of the at least three panels. Adjacent panels may be pivotally attached to each other. The system may further comprise n securing mechanism operative to secure the first panel to the last panel.

In another embodiment, an object retention system that can be hung in a closet is disclosed. The system may comprise a rigid backing with a plurality of transverse straps mounted to one or both sides of the rigid backing for holding objects; and a hook attached to an upper end of the rigid backing for hanging the system on a bar of the closet.

The transverse straps may be attached to each other where the transverse straps overlap.

The transverse straps may be attached to each other where the transverse straps overlap and may be attached to the rigid backing at such location.

Adjacent parallel straps of the transverse straps may abut each other.

Adjacent parallel straps of the transverse straps may be gapped away from each other.

The system may further comprise a frame having a thickness defining opposed first and second sides. The rigid backing may be attached closer to or at the first side. Distal ends of the transverse straps may be attached closer to or at the second side so that the transverse straps are gapped away from the rigid backing.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of an object retention system;

FIG. 2 illustrates different widths of elastic bands;

FIG. 3 illustrates an object retention system with only horizontal elastic bands with intermediate attachment points;

FIG. 4 illustrates an object retention system with only horizontal elastic bands with intermediate attachment points collectively forming various shapes;

FIG. 5 is an object retention system with only horizontal elastic bands and intermediate attachment points collectively forming a picture;

FIG. 6 illustrates an object retention system with only horizontal elastic bands and intermediate attachment points forming a series of repeating shapes and patterns;

FIG. 7 illustrates a close up view of the elastic bands having a sticky friction material so that objects do not slip out of the object retention system when vibrated or shaken;

FIG. 8 illustrates an object retention system slidably mountable to a dry erase board;

FIG. 9 is a perspective view of a divider with an object retention system removably attachable to the divider;

FIG. 10 is a front view of the object retention system and divider shown in FIG. 9;

FIG. 11 illustrates an object retention system removably attachable to a slat wall panel;

FIG. 12 illustrates the object retention system used as a cable management system;

FIG. 13 illustrates the object retention system wherein the elastic bands form a pattern;

FIG. 14 illustrates an object retention system removably attachable to a clip;

FIG. 15 illustrates the object retention system permanently integrated into a dry erase board;

FIG. 16 illustrates an object retention system incorporated into a binder;

FIG. 16A illustrates a first embodiment of an outer surface of the binder shown in FIG. 16;

FIG. 16B illustrates a first embodiment of an inner surface of the binder shown in FIG. 16;

FIG. 16C illustrates a second embodiment of the outer surface of the binder shown in FIG. 16;

FIG. 16D illustrates a second embodiment of the inner surface of the binder shown in FIG. 16;

FIG. 17 illustrates an object retention system with a single tab for attaching a securing mechanism;

FIG. 18 is an illustration of a strap with an eye hole which can be secured to the tab shown in FIG. 17;

FIG. 19 is an illustration of a clip which can be secured to the tab shown in FIG. 17;

FIG. 20 is an illustration of a hooks and loops leash which can be secured to the tab shown in FIG. 17;

FIG. 21 is an illustration of a suction cup which can be secured to the tab shown in FIG. 17 by pushing the nub through the hole until the tab enters the groove of the suction cup;

FIG. 22 illustrates an object retention system with four tabs for attaching one or more securing mechanisms shown in FIGS. 18-21;

FIG. 22A illustrates the object retention system attachable to a window or a smooth interior or exterior of a boat;

FIG. 22B illustrates the object retention system attached to a divider of an office system;

FIG. 22C illustrates the object retention system attached to a glass door of a shower;

FIG. 22D illustrates the object retention system attached to a window of an automobile;

FIG. 23 is a perspective view of an object retention system capable of being attached to a rear side of a seat;

FIG. 24 is a rear view of a seat with the object retention system shown in FIG. 23 mounted thereto;

FIG. 25 illustrates a first embodiment of a tower object retention system in a non-erected position;

FIG. 25A illustrates a second embodiment of the tower object retention system in a non-erected position;

FIG. 26 illustrates the first embodiment of the tower in the erected position for holding objects on an outside of the tower;

FIG. 26A illustrates the second embodiment of the tower in the erected position for holding objects on an outside of the tower;

FIG. 27 illustrates the first embodiment of the tower in the erected position for holding objects on an inside of the tower;

FIG. 27A illustrates the second embodiment of the tower in the erected position for holding objects on an inside of the tower;

FIG. 28 illustrates a first embodiment of an object retention system capable of being hung on a rod of a closet; and

FIG. 29 illustrates a second embodiment of the object retention system capable of being hung on the rod of the closet.

### DETAILED DESCRIPTION

Referring now to the drawings, an object retention system 10 is shown. The object retention system 10 may have a first set of elastic bands 12 that extend horizontally across a support 14 parallel to each other. A second set of elastic bands 16 may also extend vertically across the support 14 transverse to the first set of elastic bands 12. The support 14 may be any type of stiff backing sufficient to retain its shape despite tension in the bands 12, 16. By way of example and not limitation, the support may be a medium density fiberboard, dry erase board, panel, etc. The first and second sets of elastic bands 12, 16 may be interwoven together to provide short sections 18 of elastic bands to hold various sized objects (e.a., electronic components, phone, pencil, etc.). To provide greater holding force, the elastic bands of the first and second sets 12, 16 may be attached to the support 14 at intermediate positions 20 to increase the holding force of the short section 18 of the elastic band.

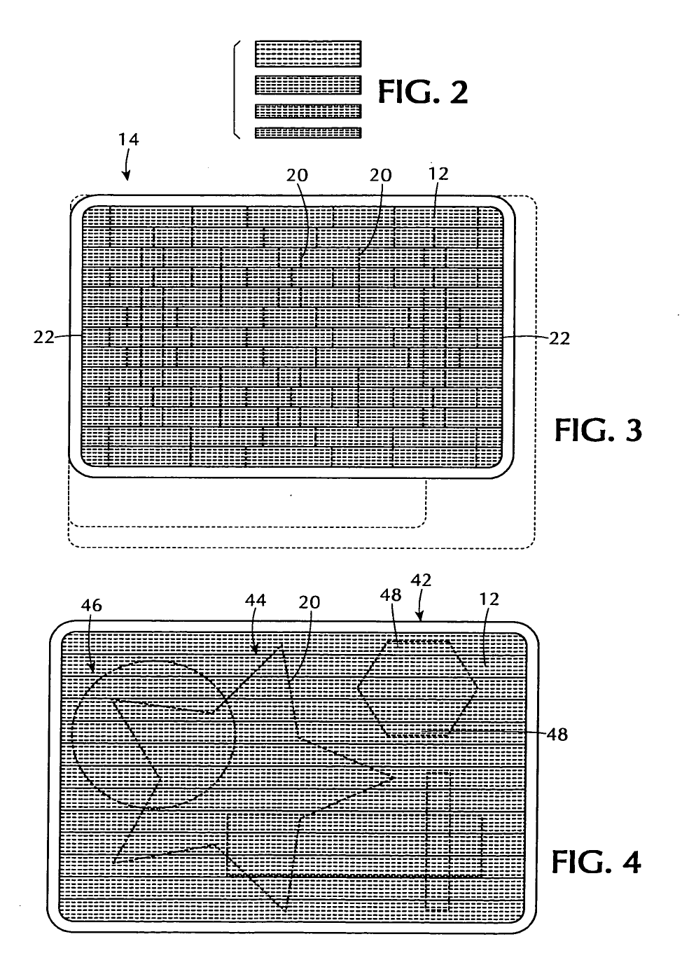

It is also contemplated that the object retention system 10 may include only the first set of elastic bands 12 as shown in FIGS. 3-6. Although the first set of horizontal elastic bands 12 is shown in FIGS. 3-6, it is also contemplated that the object retention system 10 may include only the second set of vertical elastic bands 16. Moreover, the elastic bands of the first and/or second elastic bands 12, 16 may have varying widths as shown in FIG. 2.

The first and second sets of elastic bands may be secured to a first and/or second side of the support 14.

Moreover, the anchor 20 securing the intermediate positions or portions of the sets elastic bands 12, 16 to the support 14 may collectively define a pattern as shown in FIGS. 4-6.

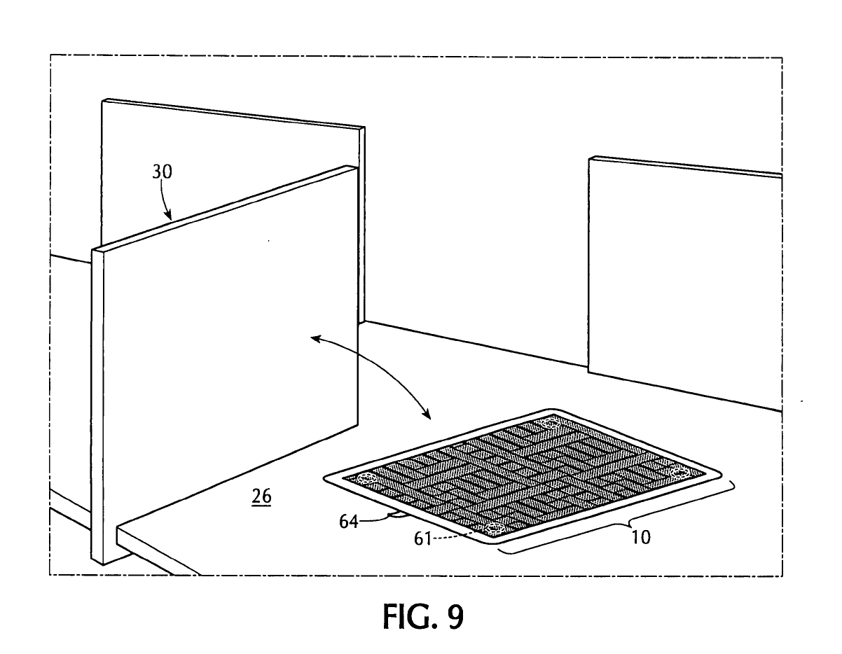

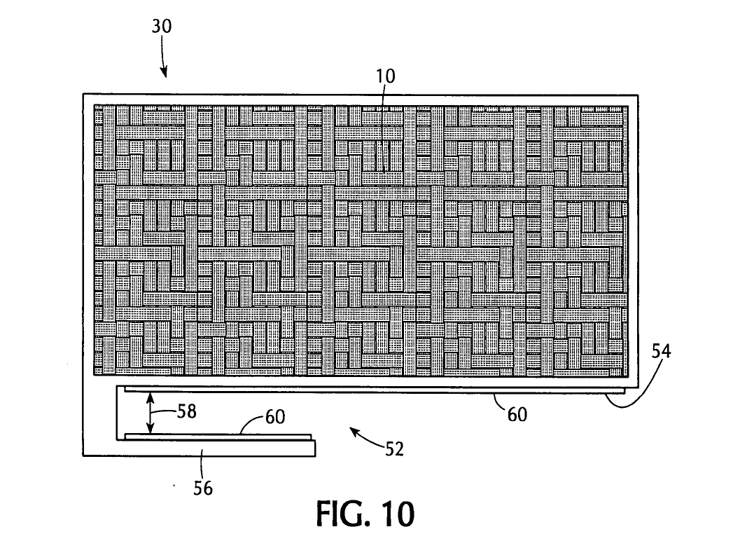

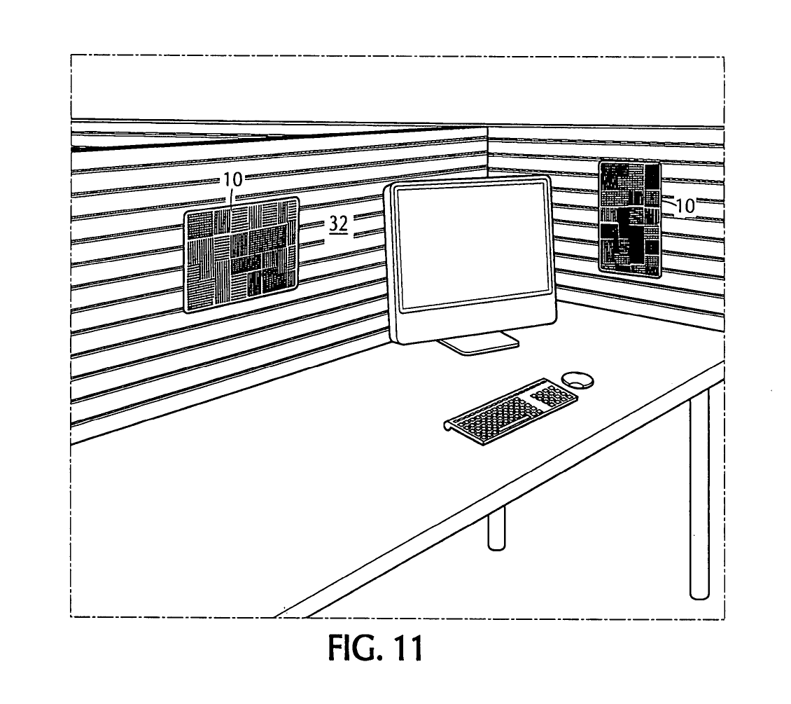

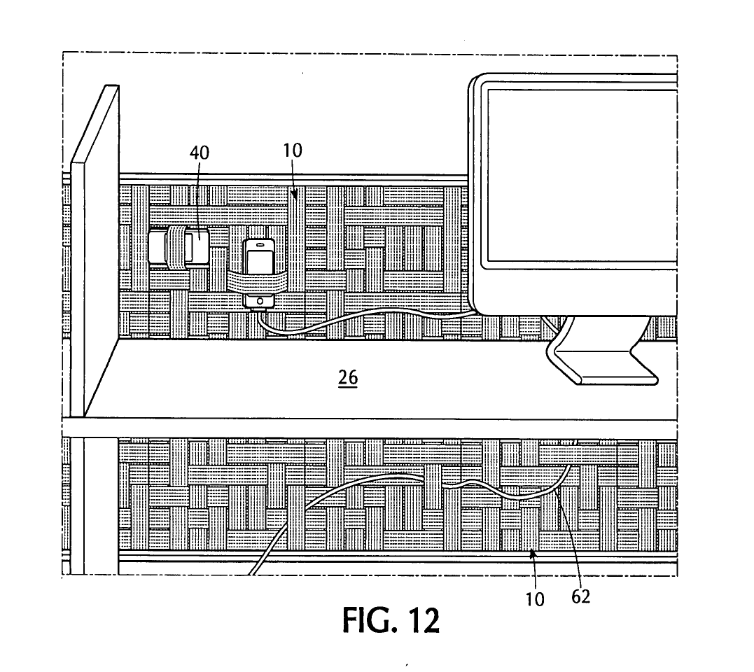

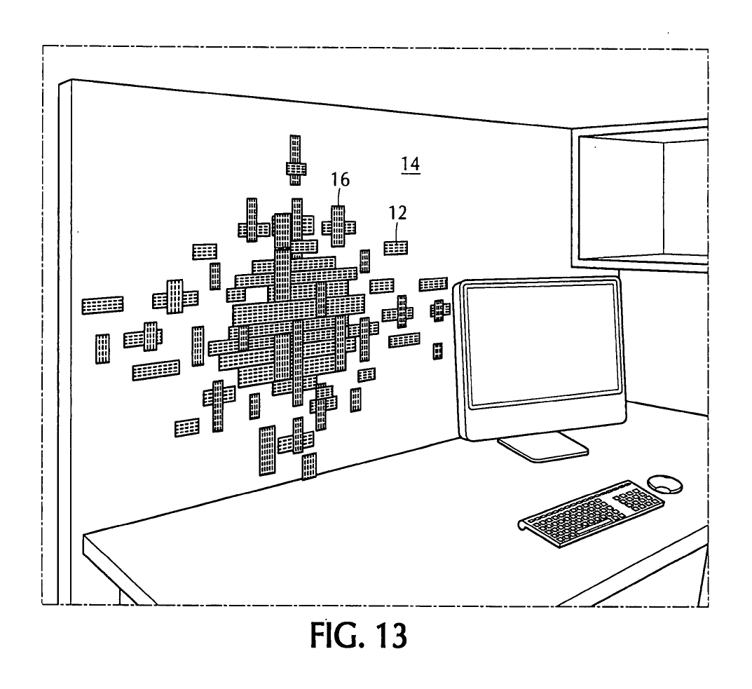

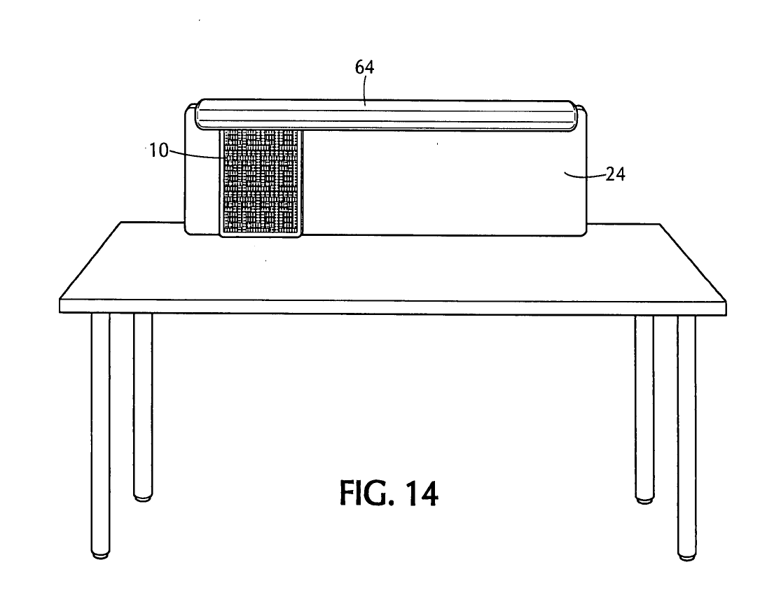

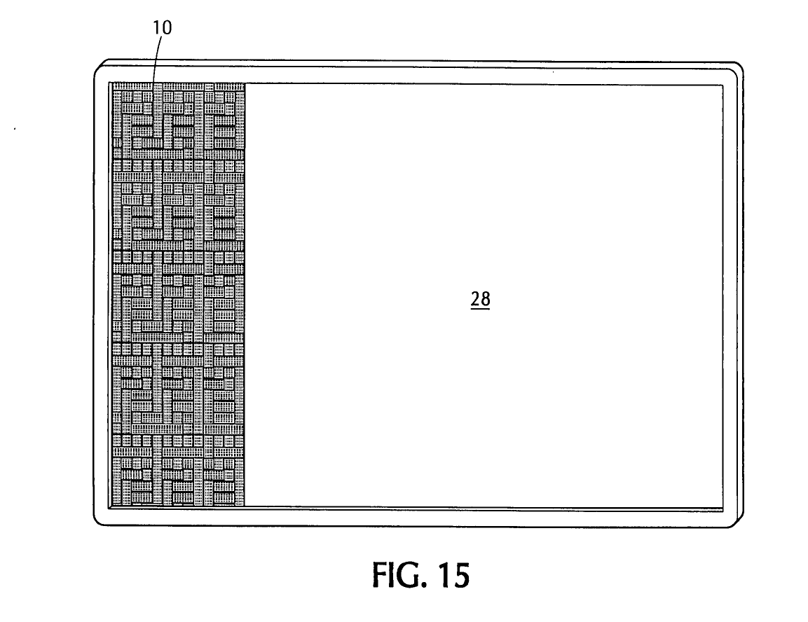

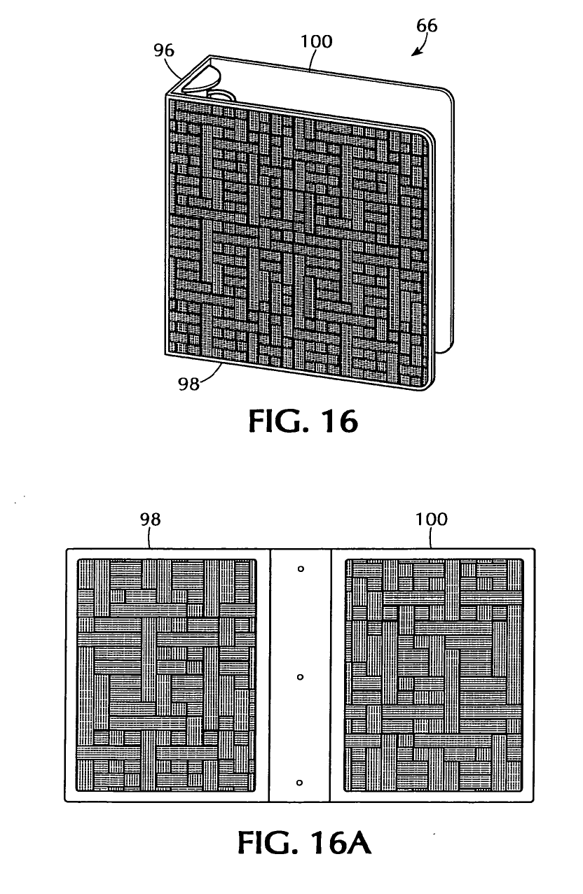

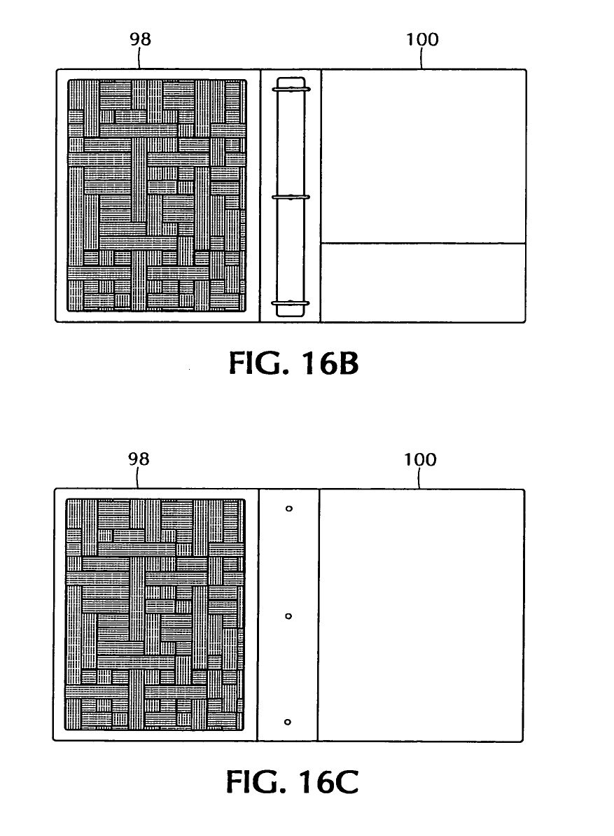

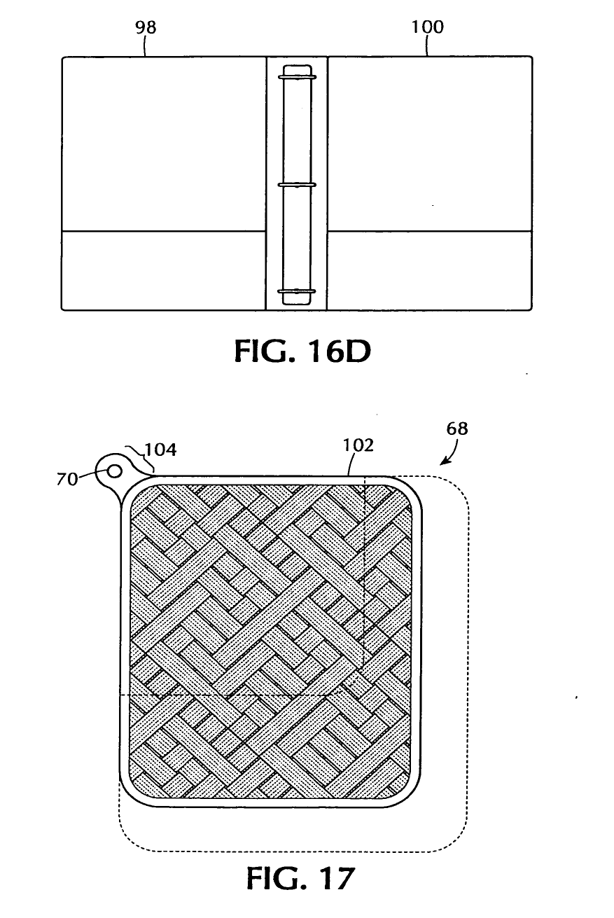

The object retention system 10 disclosed herein may be integrated into an office solution. As shown in FIG. 8, the object retention system 10 may be integrated into a panel 24 that allows the object retention system 10 to slide left and right on the panel 24. By way of example and not limitation, the panel 24 may be a dry erase board. The object retention system 10 may be hooked over the top of the panel 24 to allow for the sliding movement or other mechanisms may be utilized that are known in the art or developed in the future to accomplish the sliding movement. The object retention system 10 may be used to remove electronic devices as well as small object from the table top 26 and transfer such objects to the object retention system 10 on the panel 24. This keeps the desk top or table top 26 clear of clutter and makes employees more efficient. FIGS. 9 and 10 illustrate the object retention system 10 as an adjustable divider 30. FIG. 11 illustrates that the object retention system 10 can be removably attachable to a slat wall panel 32. Moreover, the object retention system 10 can be utilized as a cable management system as shown in FIG. 12. FIG. 13 illustrates that the object retention system 10, namely, the first and second sets of elastic bands 12, 16 may be attached to a panel (i.e., support 14) in a textural pattern. FIG. 14 illustrates that the object retention system 10 may be clipped on to the panel 24 so that object retention system may be conveniently taken home or clipped off at the end of the day. FIG. 15 illustrates that the object retention system 10 may be integrated into a dry erase board 28. FIG. 16 illustrates that the object retention system may be integrated into a paper binder 66.

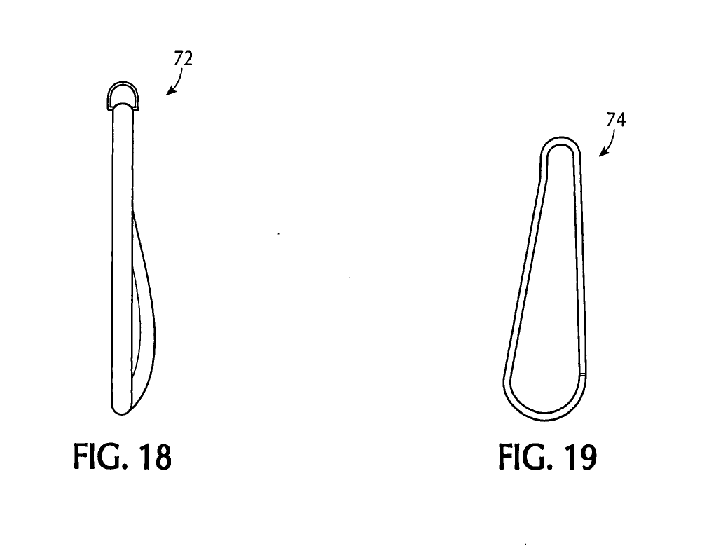

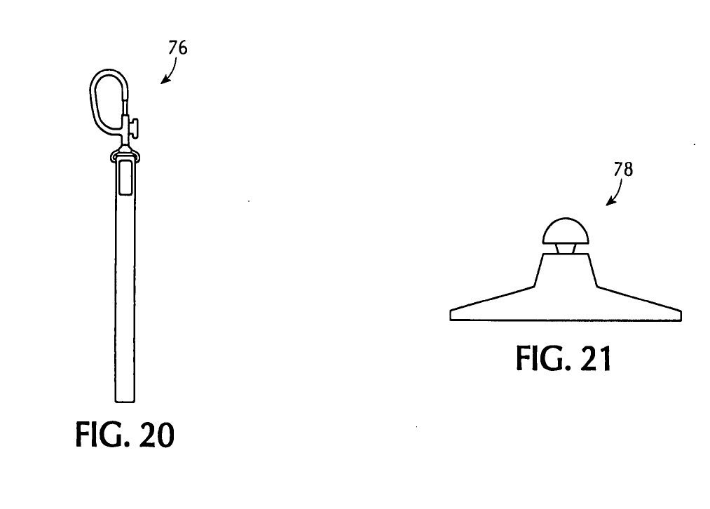

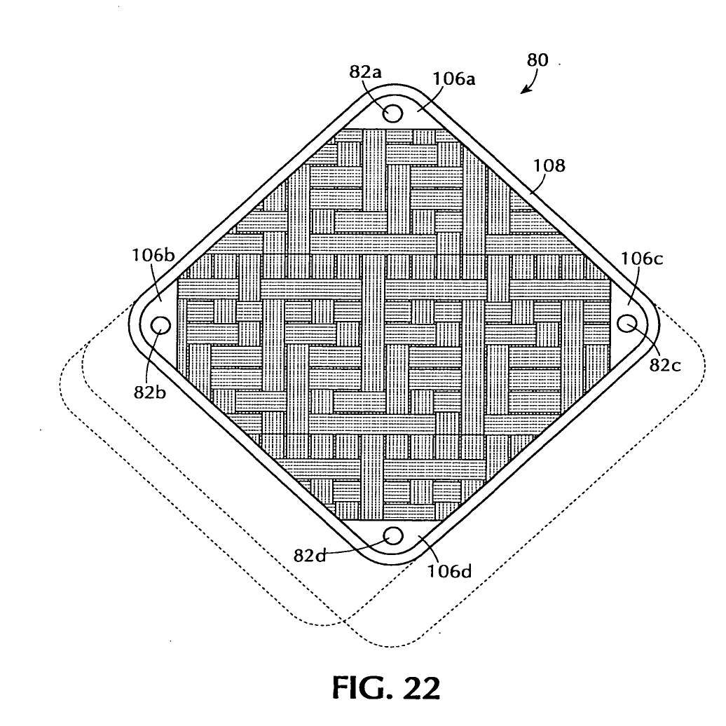

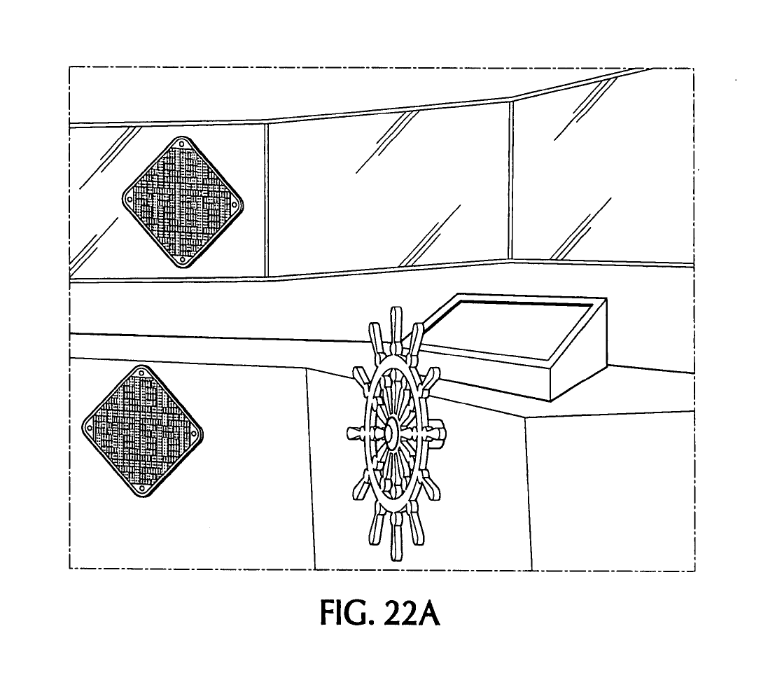

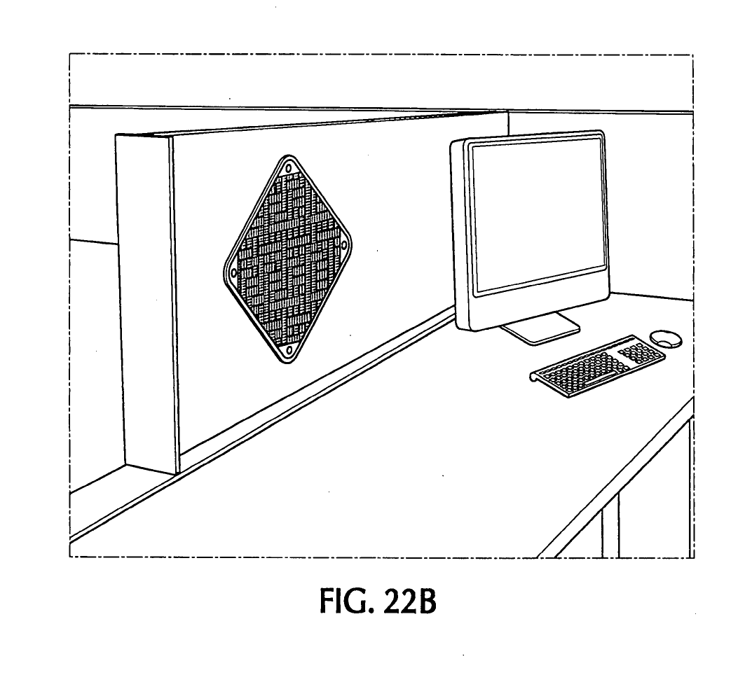

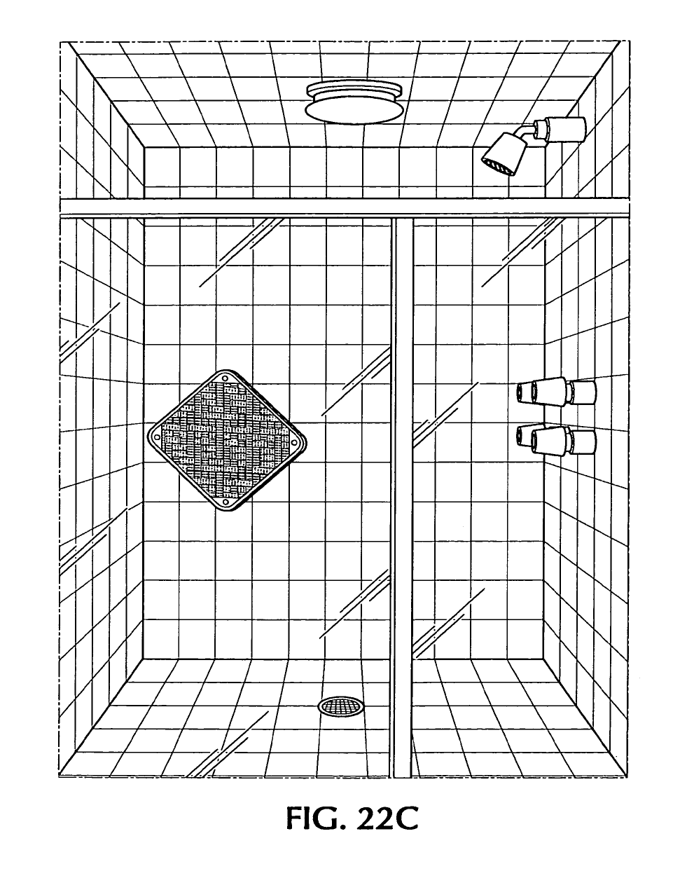

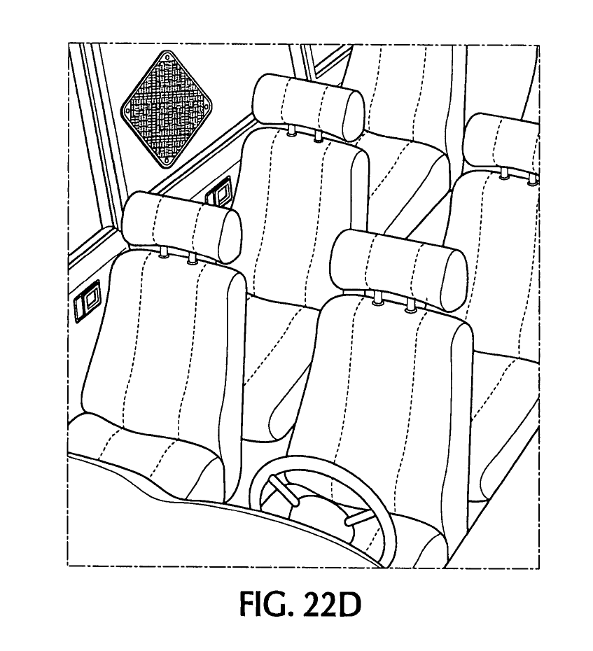

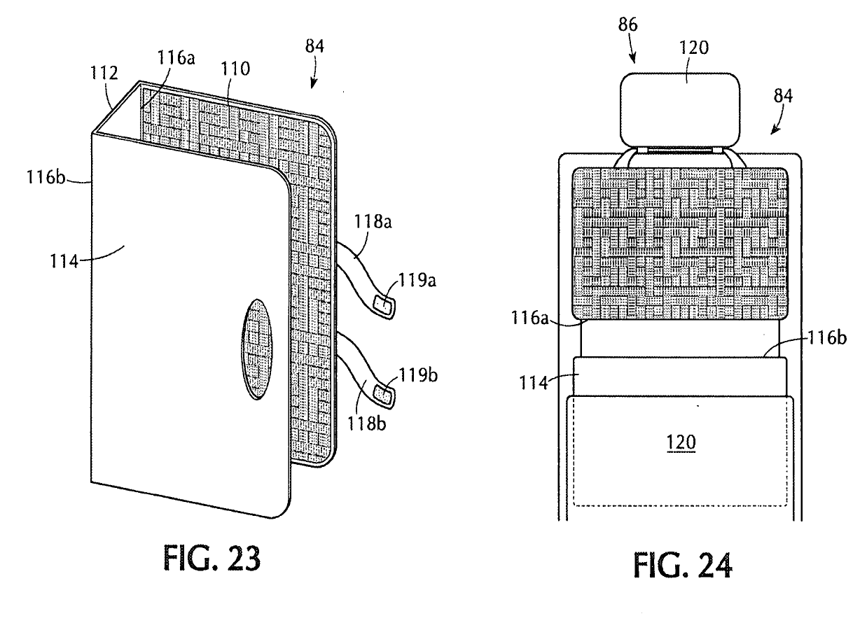

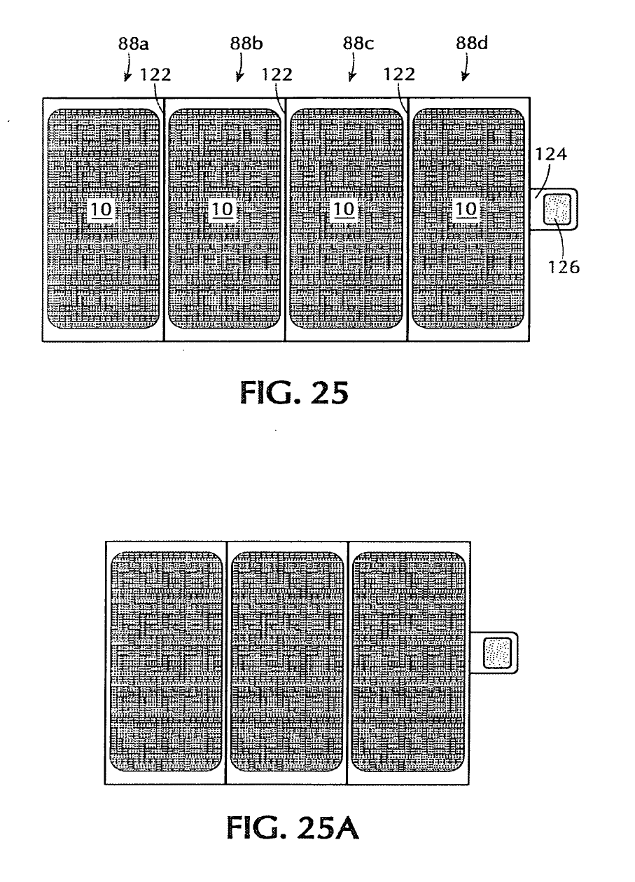

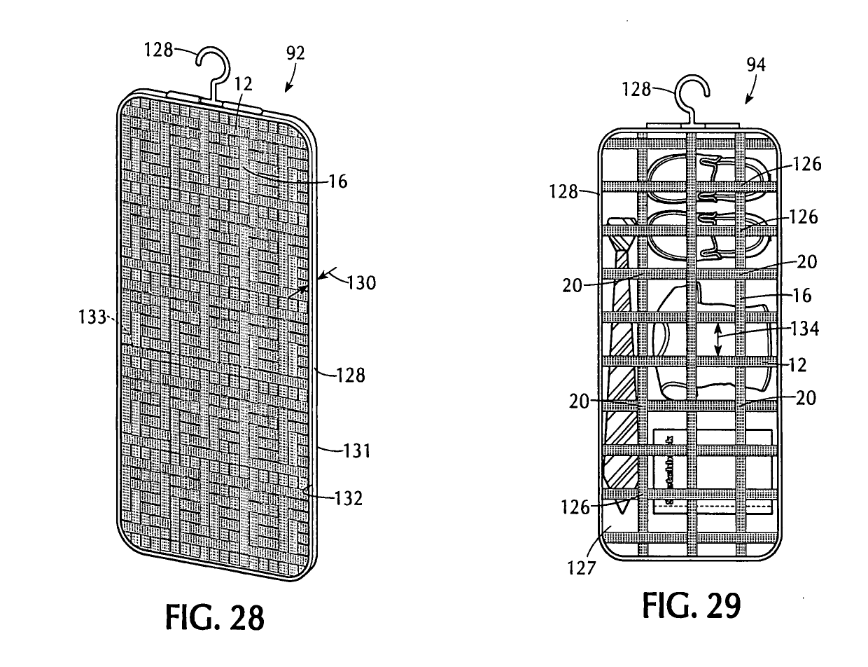

The object retention system 10 disclosed herein may also be integrated into a non-office environment. As shown in FIG. 17, the object retention system 10 may be integrated into a portable panel 68. The portable panel 68 may have an eyelet 70 for attaching one of the eyehole straps 72 (see FIG. 18), clip 74 (see FIG. 19), velcro leash 76 (see FIG. 20) or suction cup 78 (see FIG. 21). FIG. 22 illustrates a second embodiment of the portable panel 80 with eyelets 82a, b, c, d for attaching one or more of the eye hole straps 72, clips 74, velcro leash 76 and suction cup 78. FIGS. 23 and 24 illustrate an automobile panel 84 that may be mounted to a rear of an automobile seat 86. FIGS. 25-27 illustrate a plurality of panels 88a, b, c, d that may be erected as a tower 90. FIGS. 28 and 29 illustrate a panel 92, 94 for hanging in a closet. The object retention system 10 may be incorporated or integrated into the various panels shown in FIGS. 17, 22-29.

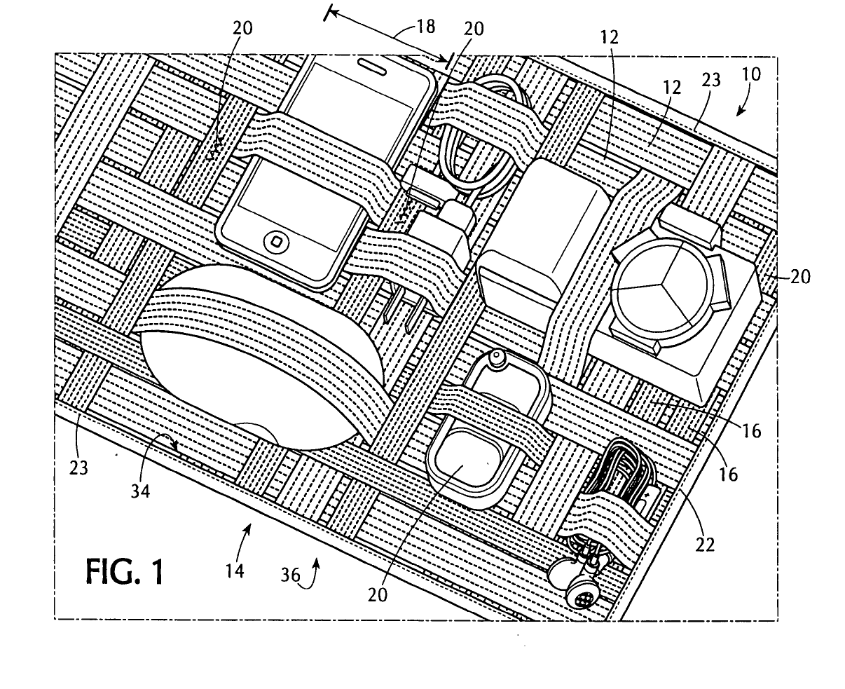

Referring now to FIG. 1, the object retention system 10 has a plurality of horizontal elastic bands 12, and vertical elastic bands 16 that are interwoven to each other. The weave may be random or organized. Also, the weave may be transverse or skewed. The horizontal and vertical bands 12, 16 are attached to a support 14. The support 14 may be a generally rigid flat surface as shown in FIG. 1. The support 14 may also be thin so that the object retention system 10 can be easily transported and conveniently placed in a pocket of a briefcase, backpack, etc. The support 14 may define a first side 34 and a second side 36. In FIG. 1, the horizontal and vertical bands 12, 14 are attached only to the first side 34. However, it is also contemplated that the horizontal and vertical bands 12, 16 may be attached to one or both of the first and second sides 34, 36 of the support 14. The first and/or second sides 34, 36 to which the horizontal and vertical bands 12, 16 are attached may have a flat configuration as shown. However, it is also contemplated that the sides 34, 36 of the support 14 to which the horizontal and vertical bands 12, 16 are attached may have other configurations such as curve, convex, concave, spherical, etc. Moreover, the support 14 is shown as having a rectangular configuration wherein its length is greater than its width. However, it is also contemplated that the support 14 and the resulting object retention system 10 may have other sizes (see FIG. 3) and configurations such as circular, polygonal, square etc. Additionally, the object retention system 10 may be incorporated into various objects such as a dry erase board, easel, furniture, office fixture, etc. In these instances, these components may be the support 14. A separate support is not needed. Alternatively, a separate generally rigid support 14 may be permanently or removably attachable to these components to add versatility and convenience.

By way of example and not limitation, in FIG. 1 a generally flat rigid support 14 is shown. The support 14 has a rectangular configuration with horizontal and vertical elastic bands 12, 16 attached to the support 14. Opposed distal ends 22, 23 of the horizontal and vertical hands 12, 16 are attached to the support 14. The opposed distal ends 22, 23 of the bands 12, 16 may be attached to the outer perimeter or edges of the support 14. It is also contemplated that the distal ends 22, 23 may be attached at a central area of the support 14.

Referring now to FIG. 2, the elastic bands 12, 16 may have different widths. Generally, the wider the width the greater the spring constant of the elastic bands 12, 16. As shown in FIG. 1, the horizontal bands 12 may have different widths. Likewise, the vertical bands 16 may also have different widths.

Each of the horizontal and vertical bands 12, 16 may also be secured to the support at intermediate positions 20, as shown in FIG. 1. These intermediate positions 20 may be hidden under the corresponding transverse band 12, 16. For example, the intermediate position 20 of the vertical band 16 secured to the support 14 may be hidden under a horizontal band 12. Likewise, an intermediate position 20 of the horizontal band secured to the support 14 may be hidden under a vertical band 16. By securing the horizontal and vertical bands 12, 16 at various intermediate positions 20, the long horizontal band or vertical band 12, 16 may form multiple short sections 18 of elastic bands 12, 16. This helps to maintain the object in the object retention system 10 by increasing the holding force that the horizontal or vertical bands 12, 16 applies to the object.

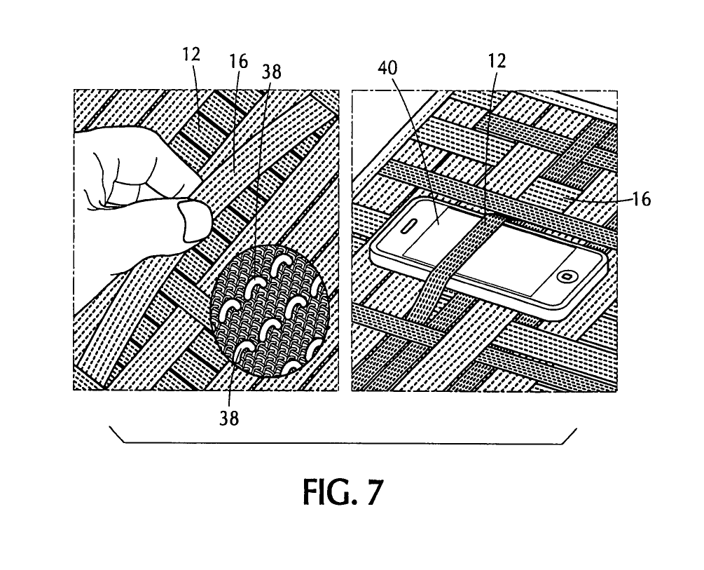

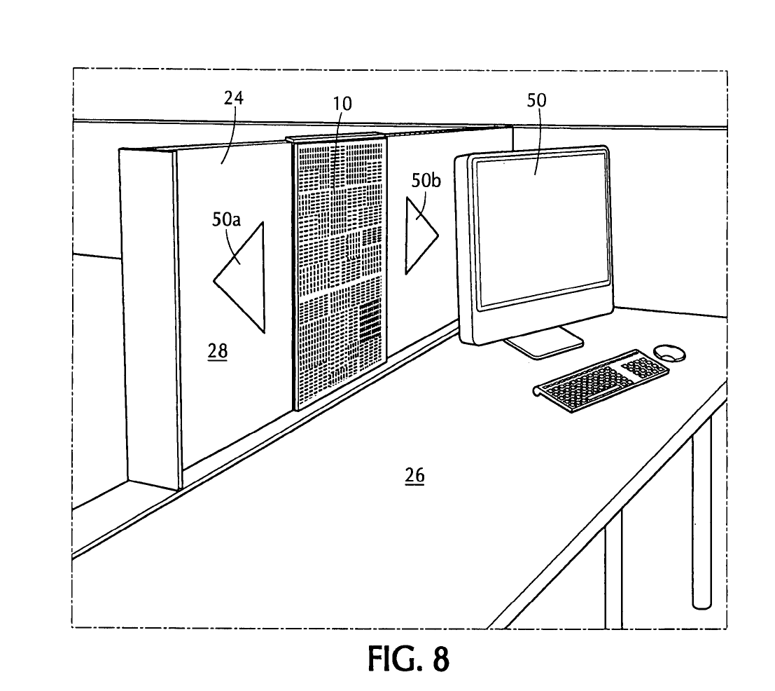

Referring now to FIG. 7, each of the horizontal and/or vertical bands 12, 16 may have a non-slip material embedded into the horizontal and/or vertical bands 12, 16. The non-slip material may have a bead configuration 38 and assists in increasing the coefficient of friction between the horizontal and/or vertical bands 12, 16 and the object 40 being retained. More particularly, the friction material may have a string configuration sold under the trademark GOODY STAYPUT as manufactured and sold by NEWELL CO. The friction material may be integrated into the bands 12, 16 by means of stitching with an industrial sewing machine for mass production

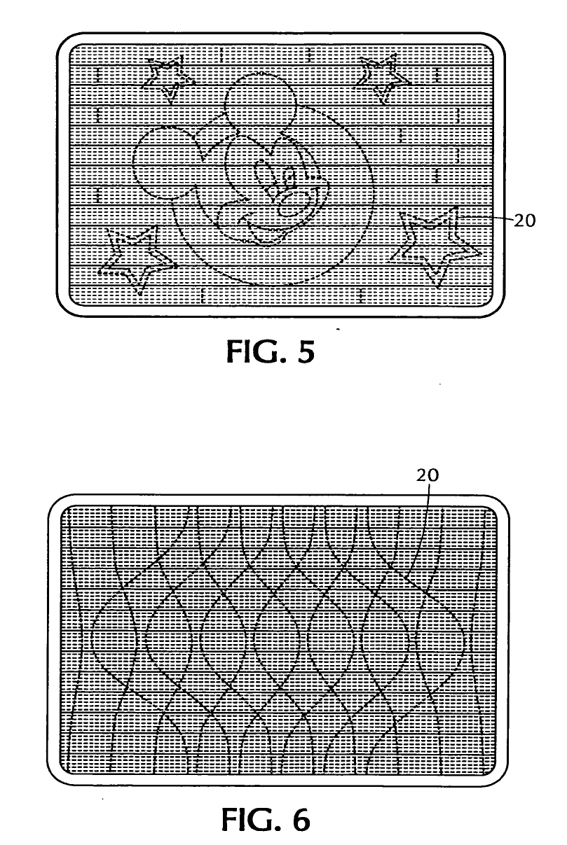

The object retention system 10 shown in FIG. 1 illustrates a double layer/cross pattern of horizontal and vertical elastic bands 12, 16. However, it is also contemplated that only horizontal bands 12 or only vertical bands 16 may be secured to the support 14. This is shown in FIGS. 3-6. In the object retention system 10 shown in FIG. 3, only horizontal bands 12 are attached to the support 14. Opposed distal ends 22 of the horizontal bands 12 are secured to the perimeter portion (i.e., left and right edge portion) of the support 14. Additionally, the bands 12 are secured to the support at various intermediate positions 20. The elastic bands 12 may be secured to the support 14 by way of stitching or other attachment method known in the art or developed in the future. If stitching is used, then the stitches may be visible to the user. In this regard, the intermediate attachments 20 or stitches may collectively form an aesthetically pleasing pattern as shown in FIGS. 4-6. The pattern may be common shapes as shown in FIG. 4. The pattern may form well known pictures as shown in FIG. 5. The pattern can repeat as shown in FIG. 6.

More particularly, the intermediate anchors (i.e., stitches) 20 may collectively form individual geometric shapes or overlapping geometric shapes. By way of example and not limitation, in FIG. 4, a hexagon pattern 42 is shown as an individual geometric pattern. Other patterns may include a star 44 or circle 46. Comparing FIGS. 3 and 4, the intermediate anchors 20 shown in FIG. 3 are perpendicular to the direction of the horizontal band 12. In FIG. 4, the intermediate anchors 20 may be perpendicular, skewed or aligned with the horizontal direction of the horizontal band 12. Such alternate alignment of the intermediate anchors 20 may create pockets 48 for holding objects 40 or create short sections 18 for holding the objects 40. Moreover, as shown in FIGS. 5 and 6, the intermediate anchors 20 may collectively form copyrightable material or any type of patterns.

Referring now to FIG. 8, the object retention system 10 may be incorporated into furniture. In FIG. 8, the object retention system 10 is incorporated into a panel or office divider 24. The object retention system 10 may be mounted to the panel 24 so that the object retention system 10 can be traversed (or slid) left or right 50a, b. The object retention system 10 may be hooked over the panel 24 to facilitate the sliding movement. The panel 24 may be a dry erase board 28 or a pinable surface. By moving the object retention system 10, various portions of the dry erase board 28 can be revealed. The user can mount objects 40 to the object retention system 10 to clear clutter from the table top 26. The objects 40 can be slid behind the monitor 50 when not in use and slid in the direction of 50a when access to the objects 40 is required. In this manner, the user has access to the dry erase board 28 as well as the object retention system 10 as desired and needed. The object retention system 10 may be slidable left or right 50a,b with respect to the panel 24 through any mechanism known in the art or developed in the future. By way of example and not limitation, the attachment method may be by tongue and groove or groove and tongue as well as other track configurations with ball bearings or rollers.

Referring now to FIGS. 9 and 10, the object retention system 10 may be incorporated into an adjustable divider 30 that can be placed at any position on the table top 26. The adjustable divider 30 may be utilized to separate coworkers in a bullpen office environment. The divider 30 may have a c-shaped channel 52. The bottom edge 54 and a horizontal bar 56 may define a gap 58 that is sized and configured to snuggly receive a thickness of the table top 26 as shown in FIG. 9. Magnets 60 attached to the bottom edge 54 and the horizontal bar 56 may secure the object retention system 10 to the magnetizable table top 26. Additionally, non-slip linings may line the bottom edge 54 and the horizontal bar 56 to prevent slippage or movement of the divider 30 after engagement to the table top 26. The object retention system 10 may be co-extensive with the sides of the divider 30 as shown in FIG. 10. The object retention system 10 may be removable from the divider 30 to reveal an underlying dry erase board 28, chalkboard, pin up board, etc. as shown in FIG. 9. The object retention system 10 may be mounted to the divider 30 with the use of a plurality of magnets 61. By way of example and not limitation, magnets 61 may be secured to the underside or second side 36 of the support 14. The magnet 60 may be attracted to the divider 30 which may be fabricated from or embedded with material to which the magnet 60 is attracted to (e.g., iron, etc.).

Referring now to FIG. 11, the object retention system 10 may be mountable to a slat wall panel 32. The backside or second side 36 of the object retention system 10 may have hooks that are removably attachable to the grooves formed in the slat wall panel 32. The object retention system 10 can be mounted at any location on the slat wall panel 32 to customize the work space of the user. The object retention system 10 may be attached to the slat wall panel 32 in landscape or portrait orientation.

Referring now to FIG. 12, the object retention system 10 may be employed in a larger scale format. Horizontal and vertical bands 12, 16 may be attached to a panel or wall as shown in FIG. 12. Cables may be routed under one or more of the vertical and horizontal bands 12, 16 to manage and organize the cables. Additionally, objects 40 may also be secured to the object retention system 10. The object retention system 10 may also be disposed under the table top 26 to route cables 62 between various points. The panel or wall may be a dry erase board and/or pinable surface. It is also contemplated that the support 14 of the object retention system 10 may be pinable.

Referring now to FIG. 13, the horizontal and vertical bands 12, 16 may be integrated and/or woven into the panel or support 14 so that collectively, the horizontal and vertical bands 12, 16 form an aesthetically pleasing pattern. The elastic bands 12, 16 may become a textual reminiscent of fabric wall coverings or wallpaper. Smaller lengths of horizontal and vertical bands 12, 16 may be attached to the support 14.

Referring now to FIG. 14, the object retention system 10 may be removably attachable to the panel 24 by way of clip 64. The object retention system 10 may be attached to the panel by way of clip 64 and oriented in a multitude of positions.

Referring now to FIG. 15, the object retention system 10 may also be permanently integrated into a dry erase board 28 or one that can slide left or right as discussed above. The object retention system 10 may be used to hold the dry erase pens.

A small to medium sized support 14 with horizontal and/or vertical bands 12, 16 that fits precisely into a storage type object on top of the desk surface in both a flat horizontal position and in a vertical position is contemplated.

The object retention system 10 disclosed herein may have a loop 64 (see FIGS. 9) for hanging the object retention system 10 to a hook.

Referring now to FIG. 16, the object retention system 10 may be incorporated into a binder 66. The binder 66 may be a 3-ring binder as shown in FIG. 16 or other type of binder such as a 2-ring binder. Other types of office accessories are contemplated such as pocket portfolios, report covers, clipboards, etc. The binder 66 has a spine 96, front cover 98 and a back cover 100. The object retention system 10 may be incorporated into either one of the exterior surfaces of the front and back covers 98, 100 as shown in FIG. 16C or both of the exterior surfaces of the front and back covers 98, 100 as shown in FIG. 16A. It is also contemplated that the exterior surfaces of the front and back covers 98, 100 may be void of the object retention system 10. Referring now to FIGS. 16B and 16D, the object retention system 10 may be incorporated into one, neither or both of the interior surfaces of the front and back covers 98, 100.

Referring now to FIG. 17, a portable panel 68 is shown. The object retention system 10 may be incorporated into the portable panel 68. The elastic bands 12, 16 of the first and second sets are skewed with respect to the borders of the panel 68. However, it is also contemplated that the elastic bands 12, 16 may be parallel or transverse to the border. The elastic bands 12, 16 may be skewed 45° with respect to the border edges of the portable panel 68. The portable panel 68 may have an underlying rigid back and the elastic bands 12, 16 mounted to the rigid backing to form the object retention system 10. A frame 102 may be disposed about the rigid backing and the elastic straps 12, 16. Moreover, the portable panel 68 may be fabricated in different sizes as shown by the dash lines in FIG. 17. The frame 102 may additionally have a tab 104 which juts out from the periphery and has the eye hole 70. The tab 104 may be formed at any one of the four corners or at any location along the four edges of the frame 102. Referring now to FIGS. 18-21, one of an eye hole strap 72, clip 74, velcro leash 76 or suction cup 78 may be secured to the eyehole 70 and tab 104. The eyehole strap 72 and the velcro leash 76 may be attached to the tab 104 for convenient hand carry of the portable panel 78. Clip 74 may be attached to the tab 104 to hang the portable panel 68 such as from a belt loop. The suction cup 78 may be attached to the tab 104 for securing the portable panel 68 to a window, flat surface, window door, etc. (i.e., any smooth surface).

Referring now to FIG. 22, a second embodiment of the portable panel 80 is shown. The portable panel 80 may be fabricated in different sizes as shown by the dash lines in FIG. 22. Moreover, the tabs 106a-d with holes 82a, b, c, d may be integrated within the border of the frame 108. The portable panel 80 has four tabs 106a, b, c, d for attaching one or more of the straps 72, clip 74, velcro leash 76 and suction cup 78 to the portable panel 80, and more particularly, to the tab 106a, b, c, d. One or more of the suction cups 78 may be attached to the tabs 106a, b, c, d. The suction cups 78 may be attached to a smooth surface, as shown in FIGS. 22A-D. In FIG. 22A, the portable panel 80 is mounted to a glass of a boat. In FIG. 22b, the portable panel 80 is mounted to a smooth office divider. In FIG. 22C, the portable panel 80 is mounted to a glass door of a shower. In FIG. 22D, the portable panel 80 is mounted to a window of an automobile. Although the second embodiment of the portable panel 80 has been shown in FIGS. 22A-D, it is also contemplated that the first embodiment of the portable panel 68 may be employed in these various scenarios.

FIGS. 23 and 24 illustrate the object retention system 10 incorporated into an automobile panel 84 that can be mounted to a rear of an automobile seat 86. The automobile panel 84 may have a first rigid backing 110. The retention system 10 is incorporated into the rigid backing 110. The automobile panel 84 may also include second and third panels 112, 114. The panels 110, 112, 114 may be pivotable about each other through living hinges 116a, b. The automobile panel 84 may have first and second bands 118a, b which are attached to the top edge of the panel 110. The bands 118a, b may be elastic or non stretchable. The distal ends of the bands 118a, b may also have first and second securing mechanisms 119a, b such as hooks and loops, first and second parts of snaps, a button and button hole, etc. To install the automobile panel 84, the lowest panel 114 is inserted into a storage pocket 120 on the back side of the seat 86 as shown in FIG. 24. The living hinges 116a, b help to accommodate any curvature or discontinuity on the back side of the seat 86. The object retention system 10 is oriented in the outward facing direction as shown in FIG. 24. The first and second bands 118a, b are wrapped around the head rest and secured to each other through the securing mechanism 119a, b so that the automobile panel 84 hangs from the head rest. The lowest panel 114 prevents the object retention system 10 from swinging around during movement of the vehicle.

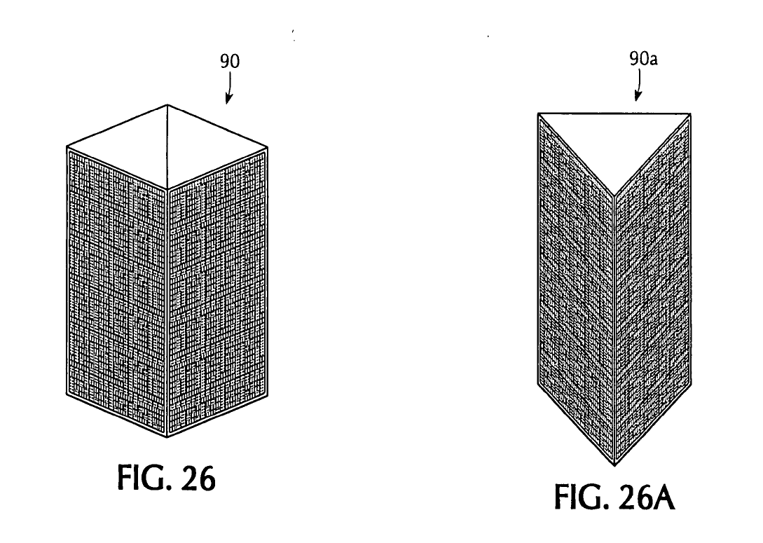

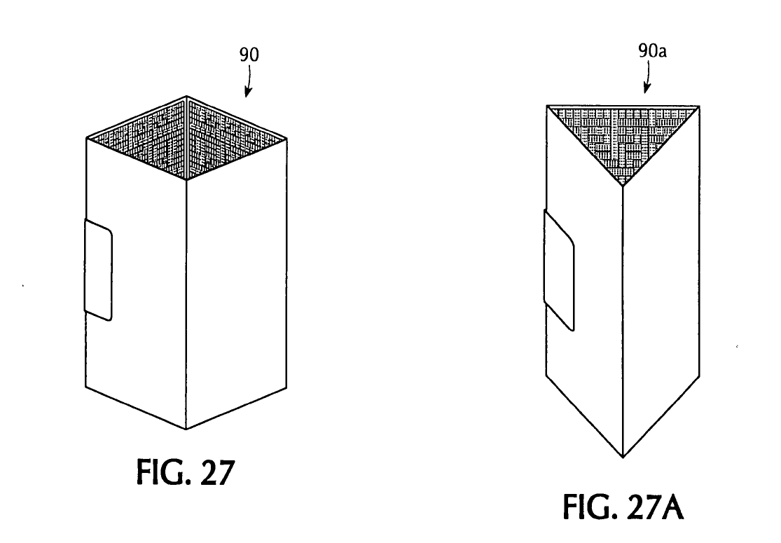

Referring now to FIG. 25-27A, two embodiments of a tower 90, 90a are shown. The first embodiment of the tower 90 is a four panel embodiment. The second embodiment is a three panel embodiment. The tower 90 may be fabricated from one or more panels 88a, b, c, d with the object retention system 10 incorporated into one or more of the panels 88a, b, c, d. These panels 88a-d may be connected to each other with living hinges 122 so that the elastic bands 12, 16 or the object retention system 10 face outside as shown in FIG. 26 or the inside as shown in FIG. 27. To hold the tower 90 in the erect position as shown in FIGS. 26-27, a tab 124 may have a securing mechanism 126 attachable to the panel 88a. In erecting the tower 90, the panels 88a-d are folded as shown in FIG. 26 or FIG. 27 and the securing mechanism (e.g., hoops and loops, snaps, etc.) secured to the back side of the panel 88a as shown in FIG. 27. These features and aspects may also be incorporated into a three panel tower 98 as shown in FIGS. 25A, 26A and 27A or a tower having five or more panels. After erecting the towers 90, 98, the towers 90, 98 may be placed on a flat surface such as desktop to remove clutter and organize a person's space.

Referring now to FIGS. 28 and 29, a panel 92, 94 may be hung in a closet. A close knit weave of elastic bands 12, 16 may be attached to an underlying rigid backing, as shown in FIG. 28. Alternatively, a wide weave of elastic bands 12, 16 may be attached to the underlying rigid backing, as shown in FIG. 29. The panels 92, 94 may have a hook 128 for hanging the panel 92, 94 on a rod. The opposed distal ends of the elastic bands 12, 16 may be secured to opposed borders of the underlying rigid backing of the panels 92, 94. However, it is also contemplated that the distal ends may be attached to a position inward from the border. One or both of the elastic bands 12, 16 may also be attached to the rigid backing at intermediate positions or anchors 20 as shown in FIG. 29. It is also contemplated that the elastic bands 12, 16 may be attached to each other but not the rigid backing where the elastic bands 12, 16 overlap one another as shown by 126 in FIG. 29. The widths of the elastic bands 12, 16 may vary as shown and discussed herein in relation to FIG. 2. The other embodiments discussed herein may incorporate the configuration and structure of the elastic bands 12, 16 discussed in relation to FIGS. 28, 29.

Referring still to FIGS. 28 and 29, the rigid backing 127 may optionally have a frame 128 having a thickness 130 defining opposed first and second sides 131, 132. The rigid backing 127 may be attached closer to or at the first side 131 of the frame. The elastic bands 12, 16 may be attached closer to or at the second side 132 of the frame 128 so that the bands 12, 16 may be gapped away from the rigid backing. Objects may be inserted between the bands 12, 16 as shown and described herein. Also, objects (e.g., shirts, shoes, notebooks, ties, etc.) may be secured under the bands 12, 16 as shown in FIG. 29. Alternatively, the elastic bands 12, 16 may be secured to the rigid backing 127 so that there is no gap between the elastic bands 12, 16 and the rigid backing 127.

In the wide weave shown in FIG. 29, the adjacent bands 12 and/or the adjacent bands 16 are gapped away from each other. The gap 134 may be greater than a width of the bands 12, 16. The gap 134 may be sufficiently large so that the desired object for which the panel 94 is designed for can fit between adjacent bands 12, 16 and be disposed under the bands 12, 16.

Referring still to FIGS. 28 and 29, the rigid backing 127 may have an optional living hinge or other pivoting mechanism 133 which allows an upper portion 134 to fold onto lower portion 136. The elastic bands 12, 16 transverse to the pivoting mechanism or living hinge 133 may optionally be attached to the rigid backing 127 at the pivoting mechanism 133.

The above description is given by way of example, and not limitation. Given the above disclosure, one skilled in the art could devise variations that are within the scope and spirit of the invention disclosed herein, including various ways of attaching the elastic bands to the support. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An object retention system comprising:
a generally rigid support;
a plurality of elastic bands attached to the generally rigid support, each of the elastic bands attached to the rigid support parallel to each other, distal end portions and intermediate portions of the bands attached to the generally rigid support for providing short band sections to hold smaller objects;
wherein the intermediate portions collectively depict an image or pattern.

2. The object retention system of claim 1 further comprising a loop attached to the generally rigid support for receiving a hook to hang the object retention system from the hook.

3. The object retention system of claim 1 wherein the support is curved, flat, convex or concave.

4. The object retention system of claim 1 wherein the elastic bands have different widths.

5. The object retention system of claim 1 wherein adjacent elastic bands abut each other.

6. The object retention system of claim 1 wherein adjacent elastic bands are gapped away from each other.

7. The object retention system of claim 1 wherein the image or pattern is a curved line, a logo, a diagram or combinations thereof.

8. The object retention system of claim 1 wherein a clip is attached to the second side for removably mounting the system to a wall, wall panel, or dry erase board.

9. The object retention system of claim 1 wherein a magnet is attached to the second side for removably mounting the system to a wall, wall panel, easel or dry erase board.

10. The object retention system of claim 1 wherein the support extends from a first cable termination point to a second cable termination point for routing one or more cables from the first to second cable termination points.

11. The object retention system of claim 1 wherein the support has a channel for receiving a desk top to mount the system to the desk top.

12. The object retention system of Claim I wherein the system can be removably clipped onto a panel.

13. The object retention system of claim 1 wherein the support is a dry erase board or an easel.

14. An office system comprising:
a table top for providing a work space to a person;
a panel disposed adjacent to the table top;
an object retention system slideably attached to the panel, the object retention system comprising:
a generally rigid support;
a plurality of elastic bands attached to the support, objects capable of being disposed between one or more of the elastic bands and the generally rigid support to hold the objects;
a sliding system attached to the panel and the object retention system to allow the object retention system to slide with respect to the panel.

15. The office system of claim 14 wherein the object retention system slides laterally or vertically with respect to the panel.

16. An office system comprising:
a table top for providing a work space to a person;
a panel removably attachable to the table top;
an object retention system attached to the panel, the object retention system comprising:
a plurality of elastic bands attached to the panel, objects capable of being disposed between one or more of the elastic bands and the panel to hold the objects.

17. The office system of claim 16 wherein the panel has a C shaped channel which receives the table top to removably attach the panel and the object retention system to the table top.

18. The office system of claim 16 wherein the panel and the object retention system has a magnet attachment system for removably attaching the object retention system to the panel, the magnet system comprising:
a first part of the magnet system attached to the panel; and
a second part of the magnet system attached to the object retention system;
wherein the first part and the second part are magnets, a magnet and a ferromagnetic material or a ferromagnetic material and a magnet.

19. The office system of claim 16 wherein the panel is a dry erase board and the object retention system is removably attachable to the panel to cover the dry erase board.

20. An office system comprising:
a table top for providing a work space to a person;
a slatwall panel disposed adjacent to the table top;
an object retention system attachable to the panel, the object retention system comprising:
a generally rigid support;
a plurality of elastic bands attached to the support, objects capable of being disposed between one or more of the elastic bands and the generally rigid support to hold the objects;
a plurality of slatwall panel hooks attached to the generally rigid support for mounting the object retention system to the panel.

21. The office system of claim 20 wherein the object retention system has a rectangular configuration and is mountable to the slatwall panel in a portrait or landscape orientation.

22. A cable management device comprising:
a generally rigid support;
a plurality of first elastic bands attached to the generally rigid support, each of the elastic bands arranged parallel to each other, distal end portions and intermediate portions of the bands attached to the generally rigid support;
a plurality of second elastic bands attached to the second side of the generally rigid support at an angle greater than 1 degree up to and including 90 degrees with respect to the plurality of first elastic bands;
wherein the generally rigid support being attachable to a wall or panel for routing and securing one or more cables from a first termination point to the second termination point.

23. A paper binder comprising:
a spine defining front and back edges;
a front cover pivotally attached to the front edge of the spine;
a back cover pivotally attached to the back edge of the spine;
a plurality of transverse straps attached one or both of the front and back covers.

24. The binder of claim 23 wherein the plurality of transverse straps are attached one or more of interior and exterior surfaces of the front and back covers.

25. An all purpose object retention system comprising:
a rigid backing defining opposed surfaces;
a plurality of transverse straps mounted to one or both of the opposed surfaces of the rigid backing;
a border disposed about a periphery of the rigid backing, the border having at least one tab for securing an attachment mechanism to the object retention system.

26. The system of claim 24 wherein the border has four tabs, one tab at a corner of a rectangular rigid backing.

27. The system of claim 24 wherein the tab has a hole which permits attachment of one or more of an eye hole strap, clip, leash and suction cup to the tab.

28. An object retention system for mounting to a rear side of an automobile seat, the system comprising:
an upper panel having a plurality of transverse straps;
a securing mechanism comprising first and second bands attached to the upper panel which ends are removably attachable to each other for securing the upper panel to a head rest of the automobile seat;
a lower panel pivotal with respect to the upper panel;
wherein the lower panel is insertable into a back pocket of the automobile seat.

29. The system of claim 28 further comprising an intermediate panel with the upper and lower panels pivotally secured to opposed sides of the intermediate panel.

30. An upright object retention system, the system comprising:
at least three serial panels with a plurality of transverse straps attached to one or more of the at least three panels, adjacent panels pivotally attached to each other;
an securing mechanism operative to secure the first panel to the last panel.

31. An object retention system hangable in a closet, the system comprising:
a rigid backing with a plurality of transverse straps mounted to one or both sides of the rigid backing for holding objects;
a hook attached to an upper end of the rigid backing for hanging the system on a bar of the closet.

32. The system of claim 31 wherein the transverse straps are attached to each other where the transverse straps overlap.

33. The system of claim 31 wherein the transverse straps are attached to each other where the transverse straps overlap and attached to the rigid backing at such location.

34. The system of claim 31 wherein adjacent parallel straps of the transverse straps abut each other.

35. The system of claim 31 wherein adjacent parallel straps of the transverse straps are gapped away from each other.

36. The system of claim 31 further comprising a frame having a thickness defining opposed first and second sides, the rigid backing attached closer to or at the first side, distal ends of the transverse straps attached closer to or at the second side so that the transverse straps are gapped away from the rigid backing.
